(19) United States
(12) Patent Application Publication
(10) Pub. No.: US 2021/0405643 A1
(43) Pub. Date: Dec. 30, 2021

(54) Floor Assignment

(71) Applicant: Navenio Ltd., Oxford (GB)

(72) Inventors: Orfeas Kypris, Oxford (GB); Sarfraz Nawaz, Oxford (GB); Agathoniki Trigoni, Oxford (GB)

(21) Appl. No.: 17/288,782

(22) PCT Filed: Oct. 24, 2019
(86) PCT No.: PCT/GB2019/053022

§ 371 Date: Apr. 26, 2021

(30) Foreign Application Priority Data
Oct. 30, 2018 (GR) 20180100494
Dec. 11, 2018 (GB) 1820147.5

(51) Int. Cl. G05D 1/02; G01C 21/34

(52) U.S. Cl. CPC G05D 1/0219; G05D 2201/0213; G01C 21/3461

(57) ABSTRACT

A method 400 of automatically assigning segments of trajectories 110, 120, 130 to floors of a building 100 comprises receiving 801 data concerning a trajectory from a mobile device 152, the data comprising height data and ambient signal data; segmenting 802 the trajectory using the height data, such that a change in the height data marks an end region of a segment. A change in the height data between adjacent segments is referred to as a height link. The method further comprises calculating 803 similarity values for pairs of segments based on the ambient signal data; using the similarity values, grouping 804 the segments into a plurality of groups based on the ambient signal data; checking 805 for errors in the grouping using the height links; accepting 808a the grouping if the checking does not identify any errors, or re-running 807 the grouping if it does; and, once the grouping is accepted, assigning 809 the groups to corresponding floors.

The invention relates to systems and methods for assigning segments of trajectories within a building to corresponding floors of that building. In particular, but not exclusively, the invention relates to methods of using height data, such as data derived from pressure change and/or inertial data in combination with ambient signal data, for floor assignment.

The skilled person will appreciate that the ability to assign portions of a trajectory to corresponding floors of a building may be useful in various scenarios such as tracking, mapping footfall, and mapping other characteristics such as WiFi signal.

The skilled person will appreciate that current smartphone pressure sensors are generally not very accurate for absolute pressure measurements. Estimation of floor number or height based on absolute pressure may not be reliable owing to changes in environmental pressure and sensor noise, amongst other factors. Pressure comparisons between different devices (which may have different sensors, and/or differently calibrated sensors) are also generally not reliable, and, particularly in crowdsourced data, there may not be sufficient information available for accurate calibration of pressures between devices. Similar considerations may apply for other kinds of height data.

Thus in crowdsourced data where data for different trajectories may be provided by different users and/or from different devices, and for trajectories which could start and end anywhere, (inside the building, on any floor), determining which part of the trajectory was on which floor is non-trivial

According to a first aspect of the invention, there is provided a method of automatically assigning segments of trajectories to corresponding floors of a building within which each trajectory segment is located and/or to relative floor numbers. The method comprises at least one of:
a) receiving data corresponding to a trajectory from a mobile device moved along that trajectory, the data comprising height data and ambient signal data;
b) segmenting the trajectory into segments using the height data, such that a change in the height data greater than a first threshold marks an end region of one segment and a start region of an adjacent segment, a change in the height data between adjacent segments of the trajectory being referred to as a height link;
c) calculating similarity values for pairs of segments based on the ambient signal data;
d) using the similarity values, grouping the segments into a plurality of groups based on the ambient signal data;
e) checking for errors in the grouping using the height links, and in response to the checking:
f) if the checking determines that no errors exist, accepting the grouping of the segments; and
g) if the checking determines errors exist, performing one of:
   i) iteratively re-running the grouping and checking for errors (for example with an increased number of groups and/or a different random seed); or
   ii) rejecting one or more segments and corresponding trajectories (which may be thought of as outliers) and accepting the grouping;
h) once the grouping is accepted, assigning the groups to floors of the building.

It will be appreciated that re-running the grouping and checking for errors at option i) of step g) may cause steps d), e), f) and g) to be repeated in an iterative manner, until the grouping is accepted. Each time the grouping and checking is re-run, a parameter of the grouping process and/or the segments is modified to gradually modify the results until the grouping of the segments is consistent.

A change in the height data between adjacent segments of the same trajectory may be referred to as a height link.

Iteratively re-running the grouping in step i) may comprise rejecting one or more segments; and re-running the grouping without the rejected segments.

Assigning the groups to corresponding floors may be performed using height links.

The method may include a further step of assigning rejected segments to a relative and/or absolute floor, optionally in a post-processing step (i.e. after the initial grouping).

The rejected segments may be assigned to floor identifiers using the height links between segments to estimate floor transition probabilities and the similarities of a rejected segment to already floor-assigned segments of other trajectories to estimate the probability of a rejected segment belonging to that floor identifier.

A Bayesian filter may be used to make the subsequent assignment of segments to floor identifiers.

If the checking determines errors still exist, the method may comprise iii) stopping the process.

Assigning the groups to floors of the building may comprise assigning each group to a different floor of the building.

Step h) may include assigning the groups to relative floors; ie a floor assignment with no absolute correspondence to the floor of a building. Alternatively, or additionally, the assignment of the groups may be to an absolute floor; ie a floor that has an absolute correspondence with that of a building.

As used herein, the term “height data” is used for any data which may be used to provide an indication of a change in height, and/or of absolute height, of the mobile device, either alone or in combination with other data. As such, the ambient signal data may be thought of as any data that can be used to check the resultant segmentation of trajectories using the so-called height data.

Various embodiments may utilise different ambient data. Some embodiments may utilise more than one ambient data. The skilled person will appreciate that ambient data sources each provide further data that can be used to enhance the accuracy of the methods. Examples of ambient data include any of the following: radio communication data, visible light, modulated light, geomagnetic. Here radio communication data may comprise WiFi, Bluetooth, cellular radio (such as GSM; UMTS; 3G; 4G; 5G or the like), etc. Typically, an ambient signal that may be leveraged to provide further information is a signal that provides an observable pattern, that is the same, or at least similar, on repeated visits to the same location.

The height data may be, comprise, or be derived from, pressure data. The trajectory may be segmented such that a change in pressure greater than a first threshold marks an end region of one segment and a start region of an adjacent segment, and a change in pressure between adjacent segments of the trajectory may be referred to as a pressure link (i.e. the height links may be pressure links).

Assigning the groups to floors of the building, using pressure links, may comprise ordering the groups in pressure order using the pressure links.

The height data may be, comprise, or be derived from, inertial data, which may be used to segment a trajectory in an equivalent manner.

Alternatively, or additionally, the height data may be, comprise, or be derived from side channel information which can be used to determine, infer, etc. height differences between segments and used to segment a trajectory in an equivalent manner.

Side channel information may be used to augment the height data. The side channel information may provide information about the start and end of segments and/or height differences among them.

Alternatively, or additionally, the height data may be, comprise, or be derived from other sensor data. Such other sensor data may include data generated by sensors that can be used to provide height information such any of the following: altimeter data; GPS altitude data.

The skilled person will appreciate that, as used herein, the term “segmenting the trajectory” means segmenting the data corresponding to the trajectory into segments, each segment corresponding to one portion of the trajectory. Whilst a portion of a trajectory may contain multiple data points, those data points are chronologically separate from data points of another segment of that trajectory (except for potentially a small overlap where adjacent segments meet).

The skilled person will appreciate that current smartphone pressure sensors are good at detecting relative changes in pressure data, but not very accurate for absolute pressure measurements. The inventors appreciated that current smartphone sensors may be used to detect floor changes robustly, even for different devices and different environmental conditions, even when the absolute height data (e.g. absolute pressure values) are unreliable and/or when no data for calibration between devices is available.

Data corresponding to a plurality of trajectories may be received. The data for each trajectory may be from a mobile device moved along that trajectory. The data may be provided by a single mobile device or a plurality of mobile devices. In general, the entirety of the data for any one trajectory is supplied by the same device.

The height data may comprise, or be inferred from, pressure data, and the height links may comprise pressure changes between adjacent segments of the trajectory (referred to as pressure links).

The height data may comprise, or be inferred from, only pressure data, and the height links may therefore be pressure changes between adjacent segments of the trajectory (referred to as pressure links).

The height data may comprise, or be inferred from, inertial data, and the height links may comprise inertial links.

The height data may comprise, or be inferred from, only inertial data, and the height links may be inertial links.

In at least some embodiments, the height data may compromise, or be inferred from prior, and/or side channel, information. For example, such prior information may be derived from knowledge about which floors correspond to two segments. In one example, prior information indicates that a trajectory starts on a ground floor (such as GPS data indicating use of a ground floor entrance) and moves to a second floor (for example detection of a WiFi SSID only available on the second floor). In a further example, the prior information may be provided by a user providing ground truth information. Embodiments using such prior, and/or side channel, information may be made more accurate. The height links generated from this side channel information may be treated in ensuing steps as height links generated from other sources (eg pressure data); a height link may be thought of as a means of splitting one portion of trajectory from other portions of that trajectory. Embodiments using such prior, and/or side channel, information may be made more accurate.

In some embodiments, height links may be derived from a plurality of different types of data. For example, some height links may be derived from pressure, where others from side channel information.

The skilled person will appreciate that there may be timestamps and/or other metadata such as headers, checksums and the likes associated with the height data—specification that the height data comprises only pressure or inertial data in some embodiments is not intended to exclude the presence of such timestamps and/or metadata, which may be present in such embodiments.

In some embodiments, height data can also contain a measure of uncertainty of the height data, for example, variance in estimated height differences. Such embodiments may utilise this measure of uncertainty during subsequent calculations to improve the overall method accuracy.

The skilled person will appreciate that, when the height data is, comprises, or is generated from information which may be binary or otherwise non-continuous (e.g. some prior or side-channel information, such as whether or not X can be detected, with X being for example daylight, a particular SSID associated with a particular router, a particular magnetic signal or the likes), a comparison to a threshold may still be performed due to probabilistic handling of the data (for example taking into account measures of uncertainty). A likelihood of a change of floor, or correspondingly of a change in height sufficient to indicate a change in floor, may therefore be compared to a threshold likelihood and a height link created if the likelihood exceeds a threshold. In such embodiments, “a change in the height data greater than a first threshold” should be interpreted accordingly; as a change in the height data sufficient for the likelihood of a floor change having occurred to be deemed high enough to introduce a height link/separation between segments.

A similarity value may be calculated for each possible pair of segments.

The calculated similarity values may be Jaccard similarity, Tanimoto coefficient, correlation distance, dynamic time warping distance, reliability of loop closures between segments or any other similarity metric suitable for comparing two ambient signals. In some embodiments, a similarity metric may be applied to the entirety or parts of the ambient signal data of the two segments.

In embodiments where the ambient signal is WiFi data, the similarity values for the pairs of segments may be calculated based on one or more WiFi fingerprints for each segment. Similarly for other forms of ambient signal, fingerprints for that ambient signal may exist for a segment.

The similarity values may be used to generate a similarity matrix. The grouping using the similarity values may be performed using the similarity matrix.

The grouping may be clustering and the groups may be clusters formed by the clustering.

The checking for errors in the grouping may comprise:
(i) identifying any height links within a group, indicating that adjacent segments of the same trajectory have been wrongly assigned to the same group;
(ii) identifying any deviations of height links between pairs of groups above a second threshold, indicating that at least one height link between the two groups of the pair does not match an expected height difference between the two groups; and/or
(iii) identifying inconsistencies among the groups of segments. For example, group A is two floors above group B and group B is one floor above group C, but group A is four (instead of three) floors above group C.

In some embodiments, a shortest path algorithm may be used to estimate the shortest height change between two groups which estimate may then be compared to height links determined by the method. A deviation between the estimated height change and height link may highlight that there is an inconsistency.

The deviations identified in check (ii) may be standard deviations around the average height change of a height link between the two groups of each pair of groups.

The first threshold and the second threshold may be the same; a height link may have to differ by more than the expected height change for a floor change for an error to be identified.

If errors are detected the grouping of the segments may be re-run up to a predetermined number of times. Within each iteration a parameter of the grouping process may be changed and for example, the number of groups may be increased, and/or a different random seed may be chosen).

In some embodiments, if the predetermined number of groupings are performed and there are still errors, then the method may remove (ie reject) segments contributing to these errors, and optionally the entire trajectories that contain these segments. If the number of segments removed from a group is significant (e.g. more than a certain percentage of all segments in that group), the process may terminate. Grouping may be re-run without the rejected trajectories, or the grouping may be accepted without the rejected trajectories.

The assigning each group to a relative floor using the height links, may comprise:
generating an adjacency matrix of the average height differences between groups;
using the adjacency matrix, grouping the groups formed based on the ambient signal data, based on the height data, into height groups; and
assigning a relative floor identifier to each segment based on the height group.

The grouping the initial groups (the groups formed based on the ambient signal data) based on the height data may be performed using a clustering method.

A number of floors, k, within the building may be known in advance. In such cases, the grouping based on the ambient signal data may be initially set to produce k groups, i.e. the same number of groups as floors.

If the grouping based on the ambient signal data is repeated due to error identification such that more than k groups are produced, the number of groups may then be reduced back to k, or lower, by grouping based on the height data (e.g. pressure data).

The height data may be pressure data. In such cases, the first threshold may be around 0.6 millibar.

Relative floor identifiers may be utilised to generate an absolute floor identifier.

In some embodiments a group of segments may be assigned to an absolute floor of a building. In one embodiment an absolute floor is assigned to each group of segments if the floor difference between the highest and the lowest relative floor is equal to the corresponding difference in the highest and lowest absolute floors of the building, in which case relative floor identifiers may be replaced with absolute floor identifiers.

In another, additional, or alternative, embodiment, an absolute floor assignment is made if there is prior information which confirms the assignment of an absolute floor to a group. For example, a segment may be known to start at an entrance of a building on a ground floor in which case it might be assumed that the entire group of segments in that group of segments can be assigned an absolute identifier of the ground floor.

Each trajectory that was rejected during error checking can be optionally post processed (ie after the initial grouping) to re-associate it with a relative and/or absolute floor assignment. This post processing may be by way of a Bayesian filter which may use a trajectory's height links to estimate floor transition probabilities and similarity segments that are already assigned to a floor.

According to a second aspect of the invention, there is provided a machine-readable medium containing instructions that, when read by a processing unit, cause that processing unit to do at least one of:
receive data corresponding to a trajectory from a mobile device moved along that trajectory, the data comprising height data and ambient signal data;
segment the trajectory into segments using the height data, such that a height change greater than a first threshold marks an end region of one segment and a start region of an adjacent segment, a height change between adjacent segments of the trajectory being referred to as a height link;
calculate similarity values for pairs of segments based on the ambient signal data;
using the similarity values, group the segments into a plurality of groups based on the ambient signal data;
check for errors in the grouping using the height links, and in response to the checking:
if the checking determines that no errors exist, accept the grouping of the segments into each group;
if the checking determines errors exist, performing one of:
   i) re-run the grouping and checking for errors (may be with an increased number of groups and/or a different seed);
   ii) reject one or more segments and corresponding trajectories and accepting the grouping; and
once the grouping is accepted, assign the groups to floors of the building.

The instructions may further cause that processing unit to perform any of the steps described with respect to the first aspect.

According to a third aspect of the invention, there is provided a computing apparatus arranged to automatically assign segments of trajectories to corresponding floors of a building within which each trajectory is located, the computing apparatus comprising:
one or more processing units arranged to:
   receive data corresponding to a trajectory from a mobile device moved along that trajectory, the data comprising height data and ambient signal data;
   segment the trajectory into segments using the height data, such that a change in the height data greater than a first threshold marks an end region of one segment and a start region of an adjacent segment, a change in the height data between adjacent segments of the trajectory being referred to as a height link;
   calculate similarity values for pairs of segments based on the ambient signal data;
   use the similarity values, grouping the segments into a plurality of groups based on the ambient signal data;
   check for errors in the grouping using the height links, and in response to the checking:
   if the checking determines that no errors exist, accept the grouping of the segments into each group;
   if the checking determines errors exist, performing one of:
      i) re-run the grouping and checking for errors (may be with an increased number of groups and/or a different seed);
      ii) reject one or more segments and corresponding trajectories and accepting the grouping; and
   once the grouping is accepted, assign the groups to floors of the building.

The computing apparatus may additionally perform any of the steps described with respect to the first aspect.

According to a fourth aspect, there is provided a system arranged to automatically assign segments of trajectories to corresponding floors of a building within which each trajectory is located, the apparatus comprising:
a mobile device comprising sensors and arranged to be moved along a trajectory and to have an application installed thereon arranged to:
   generate, by the sensors, data corresponding to the trajectory, the data comprising height data and ambient signal data; and send the data corresponding to the trajectory; and
a processing unit arranged to:
   receive the data corresponding to the trajectory from the mobile device; segment the trajectory into segments using the height data, such that a change in the height data greater than a first threshold marks an end region of one segment and a start region of an adjacent segment, a change in the height data between adjacent segments of the trajectory being referred to as a height link;
   calculate similarity values for pairs of segments based on the ambient signal data;
   using the similarity values, group the segments into a plurality of groups based on the ambient signal data;
   check for errors in the grouping using the height links, and in response to the checking:
   if the checking determines that no errors exist, accept the grouping of the segments into each group;
   if the checking determines errors exist, performing one of:
      i) re-run the grouping and checking for errors (may be with an increased number of groups and/or a different seed);
      ii) reject one or more segments and corresponding trajectories and accepting the grouping; and
   once the grouping is accepted, assign the groups to floors of the building.

The processing unit may be remote from the mobile device.

The processing unit may be arranged to receive data corresponding to a plurality of trajectories.

The processing unit may be arranged to receive data from a plurality of mobile devices.

The processing unit may be arranged to perform any of the steps described with respect to the first aspect.

According to a fifth aspect, there is provided trajectory data for use in automatically assigning segments of trajectories to corresponding floors of a building within which each trajectory is located. The trajectory data comprises height data and ambient signal data. The trajectory data are segmented into segments based on the height data, such that a change in the height data greater than a first threshold marks an end region of one segment and a start region of an adjacent segment. The ambient signal data are matched to/aligned with the height data, and thereby assigned to a segment, by means of one or more timestamps.

According to a sixth aspect of the invention, there is provided a method of automatically assigning segments of trajectories to corresponding floors of a building within which each trajectory segment is located and/or to relative floor numbers. The method comprises at least one of:
a) receiving data corresponding to a trajectory from a mobile device moved along that trajectory, the data comprising height data and ambient signal data;
b) segmenting the trajectory into segments using the height data, such that a change in the height data greater than a first threshold marks an end region of one segment and a start region of an adjacent segment, a change in the height data between adjacent segments of the trajectory being referred to as a height link;
c) calculating similarity values for pairs of segments based on the ambient signal data;
d) using the similarity values, grouping the segments into a plurality of groups based on the ambient signal data;
e) checking for errors in the grouping using the height links;
f) depending on the outcome of the checking, performing one of the following:
   i) accepting the grouping of the segments;
   ii) re-running the grouping (for example with an increased number of groups and/or a different random seed);
   iii) rejecting one or more segments and corresponding trajectories (which may be thought of as outliers);
g) once the grouping is accepted, assigning the groups to floors of the building.

The method may include any of the steps described with respect to the first aspect.

The skilled person would understand that features described with respect to one aspect of the invention may be applied, mutatis mutandis, to any other aspect of the invention.

The machine readable medium referred to in any of the above aspects of the invention may be any of the following: a CDROM; a DVD ROM/RAM (including −R/−RW or +R/+RW); a hard drive (including a Solid State Drive (SSD)); a memory (including a USB drive; an SC card; a compact flash card or the like); a transmitted signal (including an Internet download, ftp file transfer of the like); a wire; etc.

Additionally, the skilled person will appreciate the duality of hardware and software. As such, whilst some aspects/embodiments described herein are described as being performed by software, or by hardware, the skilled person will appreciate that this need not be the case and many portions of aspects/embodiments may be performed by hardware, software, firmware or a combination of both.

There now follows by way of example only a detailed description of embodiments of the present invention with reference to the accompanying drawings in which:

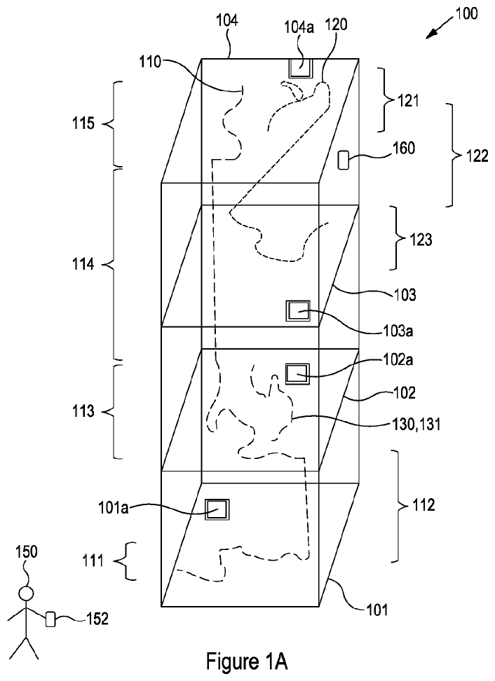

FIG. 1A shows a schematic perspective view of a building with four floors and three marked trajectories;

FIG. 1B shows a schematic view of a mobile device of an embodiment;

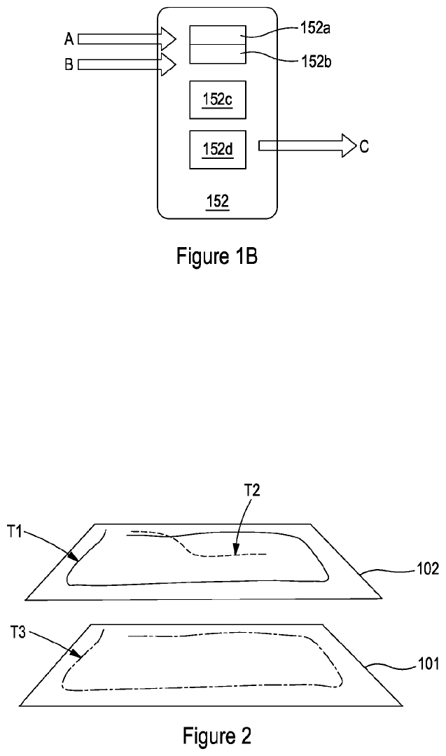

FIG. 2 shows a schematic perspective view of two floors of a building with trajectory segments marked;

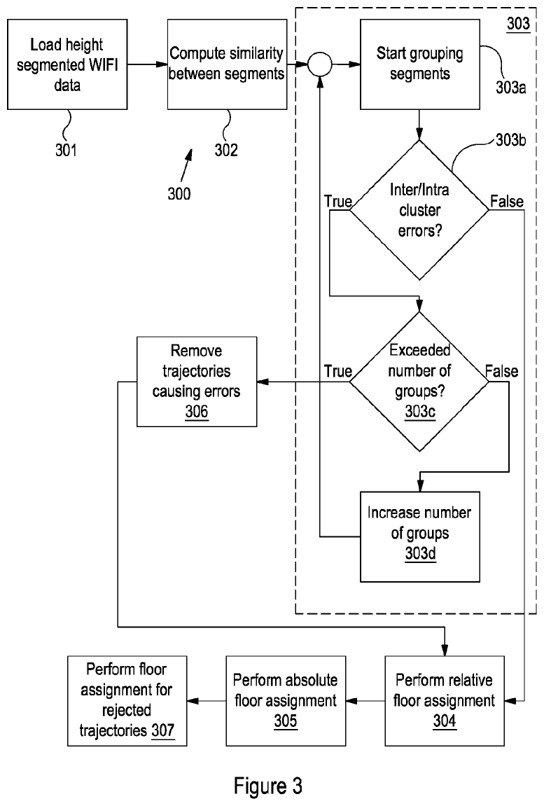

FIG. 3 shows a flow chart of a method of an embodiment; and

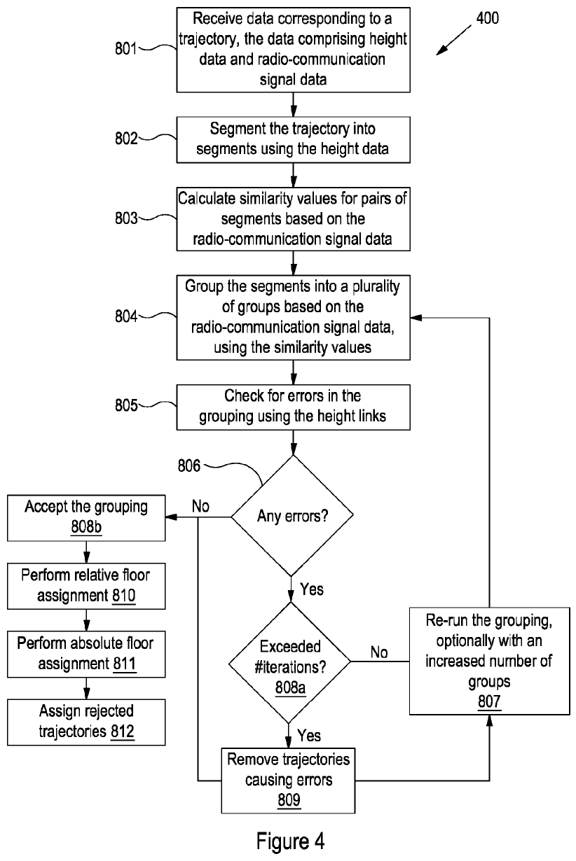

FIG. 4 shows a flow chart of a method of an embodiment.

FIG. 1A shows a building 100 with four floors 101, 102, 103, 104:
the ground floor 101 (“Floor 0”);
the first floor 102 (“Floor 1”), above Floor 0;
the second floor 103 (“Floor 2”), above Floor 1; and
the third floor 104 (“Floor 3”), above Floor 2.

The skilled person will appreciate that a building 100 may have any number of floors, and that floors 101-104 of a building 100 may have different shapes and/or sizes, in other embodiments.

People 150 can move around the building 100. The path of a person 150 within or through the building 100 is referred to as a trajectory. Three trajectories 110, 120, 130 are marked in FIG. 1A.

A person 150 may carry a mobile device 152, such as a smart phone. The skilled person will appreciate that the mobile device 152 may be any device capable of being moved around a building 100, and of detecting height and ambient signal data and processing data, and/or sending on the height and ambient data for processing elsewhere. The mobile device 152 may therefore be or comprise any suitable smart phone, tablet, portable computer (e.g. lap-top), smart watch, Fitbit®, smart clothing, subdermal electronic device or implant, or the likes. In the embodiments being described, the mobile device 152 is sufficiently small and light-weight to be carried in a hand or pocket. In other embodiments, the mobile device 152 may be larger and/or heavier, and carried in a back-pack or on a trolley or the likes. Such a mobile device may be referred to as a portable mobile device. In still further embodiments, the mobile device may be a car or other vehicle, and the building 100 may be or comprise a multi-storey car park or the likes.

In some embodiments the ambient signal data comprises radio communication signal data and it is convenient to describe an embodiment in relation to using such radio communication signal data. However, the skilled person will appreciate that ambient signal data is broader than simply radio communication data.

FIG. 1B illustrates a schematic view of a mobile device 152 showing some of the components thereof. The mobile device 152 comprises sensors 152a, 152b, which may comprise, in various embodiments, two or more of a radio-communication signal sensor, an accelerometer, a gyroscope, a barometer (ie a pressure sensor), an ambient light sensor, a camera, a temperature sensor, and a compass, or similar. Each of the sensors 152a, 152b generates data. For example, the accelerometer generates acceleration data, the barometer generates pressure data, the temperature sensor generates temperature data, etc.

The mobile device is arranged to process the data generated by the sensors (for example, the acceleration data, the pressure data, the temperature data, etc). In the embodiment being described, in which the mobile device is a smart phone, the phone is arranged to run a software application (often known as an App) which causes the mobile device to store, from time to time, the data generated from at least some of the sensors in the internal memory of the mobile device 152. In alternative embodiments, the data generated from at least some of the sensors may be immediately sent on, and may not be stored locally.

In the embodiments being described, the mobile device 152 comprises a radio-communication signal sensor 152a arranged to detect a radio-communication signal (receipt of which is indicated by arrow A in FIG. 1B). In the embodiments being described, the radio-communication signal sensor 152a is a WiFi sensor and the radio-communication signal is a WiFi signal. In alternative or additional embodiments Bluetooth®, cellular (eg GSM, UMTS, 3G, 4G, 5G, etc) or other radio communication signals may be used instead of or as well as WiFi; herein, WiFi is specified for convenience only and the skilled person will appreciate that any other suitable communication data may be used instead—the invention is therefore not to be limited to the use of WiFi. The sensed information is referred to as radio-communication signal data.

In the embodiments being described, the mobile device 152 comprises a sensor 152b arranged to provide information relating to a height of the mobile device (height data); in the embodiments being described, the sensor 152b is a pressure sensor.

In the embodiments being described, the pressure data from the pressure sensor 152b is used as, or at least used to determine, height data. Detection of pressure is indicated by arrow B in FIG. 1B. In alternative or additional embodiments, inertial data (which allows changes of height to be identified) may be used as, or at least to determine, height data, instead of or as well as pressure data. The skilled person will appreciate that other forms of height data known in the art may be used instead of or as well as these examples.

In the embodiment being described, the mobile device 152 also comprises processing circuitry 152c. The processing circuitry 152c may be or comprise one or more of the following processors: A7, A8, A9, A10 or A11 processors from Apple®, Snapdragon, IntelAtom, or the likes. The processing circuitry 152c executes the software App to collect the data generated by the sensors 152a, b as described elsewhere.

In the embodiments being described, the mobile device 152 is arranged to gather data (that is, to store data generated by the sensors and/or send it on for processing) corresponding to the trajectory 110, 120, 130 as the person 150 carrying that mobile device 152 moves within the building 100. In the embodiments being described, the data corresponding to the trajectory 110, 120, 130 comprises the height data and the radio-communication signal data.

The skilled person would appreciate that some embodiments could be performed using only a single mobile device 152 (and optionally only a single trajectory if the trajectory visits several floors and at least some of those floors multiple times). The mobile device 152 could perform processing of the height data in such embodiments.

In other embodiments, data from multiple mobile devices 152 is gathered and processed.

In the embodiments being described, the mobile device 152 is arranged to send (indicated by arrow C in FIG. 1B) the data corresponding to the trajectory 110, 120, 130 to a processing unit 160 for processing. The sending unit 152d of the mobile device 152 is arranged to send the data to the processing unit 160.

In the embodiment being described, data generated by the sensors 152a,b, including the data corresponding to the trajectory, is sent from time to time to the processing unit 160. That is the internal memory of the mobile device 152 is used to cache the data generated by the sensors. However, other embodiments may be arranged to stream the data generated by the sensors as the data is received from the sensor by the processing circuitry 152c of the mobile device.

In the embodiment being described, the processing unit 160 is not a part of the mobile device 152, and may therefore be referred to as a remote processing unit 160. In alternative or additional embodiments, some or all of the processing described below may be performed at the mobile device 152.

In the embodiment being described, the processing unit 160 is located within the building 100. As such, the mobile device 152 may be near to the processing unit 160 at times; the processing device 160 is described as “remote” for clarity of the separation irrespective of physical distance.

In embodiments in which data from multiple mobile devices 152 is gathered and/or the mobile device 152 is arranged to send the data corresponding to the trajectory 110, 120, 130 to a processing unit 160 for processing, the mobile device 152 has communication/data transfer capabilities (indicated by the sending unit 152d). One or more network connections may be available to the sending unit 152d for data transfer; for example via the Internet, but the skilled person would appreciate that any suitable data transfer means may be used. For example, Wi-Fi, the Global System for Mobile communications (GSM) and/or the Universal Mobile Telecommunications System (UMTS) may be used. Whilst it is convenient to use a Wide Area Network (WAN) such as the Internet any data connection such as an ad-hoc network, a dedicated connection between the mobile device 152 and the processing unit, etc. may be used.

The remote processing unit 160 receives data corresponding to a trajectory from a mobile device 152 moved along that trajectory 110, 120, 130. The remote processing unit 160 may receive data for a plurality of trajectories 110, 120, 130. The remote processing unit 160 may receive data from a plurality of different mobile device 152, which may be associated with different people 150. Indeed, it is convenient if the remote processing unit 160 received a plurality of trajectories from a plurality of mobile devices. For example, it is convenient if the processing circuitry receives data from 100s or 1000s of trajectories. However, for convenience and clarity only 3 trajectories are shown in the Figures.

The processing unit 160 segments each trajectory 110, 120, 130 into one or more segments. Each trajectory 110, 120, 130 is segmented using the height data provided for that trajectory. More specifically, changes in height of the trajectory (found using the height data) are used to segment the trajectory into segments at different heights.

A change in height greater than a first threshold marks an end region of one segment and a start region of an adjacent segment; it being inferred from the height data that the trajectory at that point has transitioned from one floor to another.

In the embodiment being described, the height data is pressure data and the first threshold is a change in pressure of 0.6 millibar, which is the pressure change often expected between consecutive floors of a building. The magnitude of a change in pressure may therefore be taken as an indication of how many floors have been passed—for example a change of around 1.2 millibar (or more generally, of around twice the first threshold) may be taken to indicate a change of two floors, etc. The skilled person will appreciate that the first threshold may be set based on an average spacing between floors in general, or may be tailored to an individual building, to a particular city, and/or to an average altitude (which may be determined by e.g. matching GPS data with altitude data).

In the embodiment being described, the first threshold is 0.6 millibar. In alternative embodiments, the first threshold may be 0.5, 0.55, 0.65, 0.7 or 0.75 millibar. In alternative or additional embodiments, the first threshold may be set as any value between 0.2 millibar and 1 millibar, or between 0.3 millibar and 0.9 millibar, or between 0.4 millibar and 0.8 millibar. The skilled person will appreciate that a larger pressure change may be set as the threshold for a building 100 for which floors are known to be more widely spaced than average, and/or for a building at a lower altitude (at which atmospheric pressure changes more rapidly with height), and vice versa.

FIG. 1A shows three different trajectories 110, 120, 130.

The first trajectory 110 is formed by a person 150 walking around on Floor 0, as shown by portion 111, taking a lift up to Floor 1, as shown by portion 112, walking around on Floor 1, as shown by portion 113, taking a lift up to Floor 3, as shown by portion 114, and walking around on Floor 3. The trajectory 110 then terminates, for example due to the person 150 turning off the mobile device 152 or disabling an application arranged to send the trajectory data to the remote processing unit 160.

In the embodiment being described, the portions 112, 114 of the trajectory 110 for which the person 150 was in a lift have a short duration as compared to the portions 111, 113, 115 for which the person 150 was walking around a floor of the building 100. No data, or very few data points, may therefore be sent during the floor-change portions, whereas more data may be sent for each walking portion.

The trajectory 110 is segmented into three segments corresponding to portions 111, 113 and 115. The change in height between Floor 0 and Floor 1, which is greater than a set threshold (the first threshold), triggers the separation of the first segment 111 from the second 113. The change in height between Floor 1 and Floor 3, which is greater than the threshold, triggers the separation of the second segment 113 from the third 115.

In the embodiment being described, any data points corresponding to data gathered during the height change (portions 112 and 114) are discarded as height is not stable for these points. In the embodiment being described, trajectory segmentation outputs timestamps corresponding to the start and end of each segment. Any pressure and ambient signal data (eg Wi-Fi scan data in the embodiment being described) outside these timestamps is not considered. These data relate to the staircase, elevator or the likes and do not belong to either of the floors.

In alternative embodiments, the data points corresponding to data gathered during the height change (portions 112 and 114) may be included with whichever segment they are closest to in height.

Each change in height therefore marks an end region of one segment and a start region of an adjacent segment.

The change in height may occur between two data points (e.g. for low-frequency data collection, a high-speed change, and/or limited data collection during the transition due to the structure of e.g. a lift blocking transmission). In this case, the change in height would mark the end of one segment and start of the next, with the data point on one side of the change being the last data point in the first segment and the adjacent data point, on the other side of the change, being the first data point in the second segment. In alternative embodiments, data points immediately adjacent to a change may be discarded as potentially unreliable, so the change may indicate a start and end region rather than a precise start and end point of the adjacent segments.

The change in height may occur over multiple data points (e.g. for high-frequency data collection, a low-speed change, and/or a change using a staircase instead of a lift). In this case, the points during the transition may be discarded, may all be associated with one segment, or may be split between adjacent segments.

In some embodiments, a set number of data points without a height change are used for a new segment to be established. As such, if a person gets half-way up a flight of stairs, turns around and goes back down to the same floor as previously (i.e. no overall pressure change), no new segment may be created. The data points during the height change may be discarded. A set time period of data collection may be used instead of a set number. Alternatively or additionally, if an unusual height change pattern has been detected, the trajectory may be stopped and a new trajectory started such that a height link involving the unusual height change pattern is not relied upon.

The skilled person will appreciate that, whatever the chosen implementation details, changes in height are used to identify an end region of one segment and a start region of an adjacent segment, and therefore to segment the data.

The change in height between the first segment 111 and the second segment 112 of the trajectory 110 is referred to as a height link between those segments.

The change in height between the second segment 113 and the third segment 115 of the trajectory 110 is referred to as a height link between those segments.

In the embodiment being described, the height data is pressure data, with the change in pressure indicating a change in height. The height links may therefore be referred to as pressure links.

The second trajectory 120 is formed by a person 150 walking around on Floor 3, as shown by portion 121, taking the stairs down to Floor 2, as shown by portion 122, and walking around on Floor 2, as shown by portion 123. The trajectory 120 then terminates, for example due to the person 150 turning off the mobile device 152 or disabling an application arranged to send the trajectory data to the remote processing unit 160.

In the embodiment being described, the portion 122 of the trajectory 120 for which the person 150 was on the stairs has a similar duration to the portions 121, 123 for which the person 150 was walking around a floor of the building 100. A similar number of data points may therefore be sent during the floor-change portion as for each portion on a floor.

The trajectory 120 is segmented into two segments corresponding to portions 121 and 123. The change in height between Floor 3 and Floor 2 triggers the separation of the first segment 121 from the second 123. In the embodiment being described, the data for the intervening portion 122 for which the person 150 was on the stairs is discarded. The height change between the two segments is recorded as a height link.

The third trajectory 130 is formed by a person 150 walking around on Floor 2. There is no height change and so the entire trajectory 130 is treated as a single segment 131.

The skilled person will appreciate that, whilst the approach described herein is designed to work with a large number of trajectories 110-130, a single trajectory covering multiple floors and returning to at least some of the multiple floors could be used alone in the same way.

In the embodiment shown in FIG. 1A, a WiFi access point 101a-104a is present on each floor 101-104. The skilled person will appreciate that any other radio-communication signal-providing units may be used in alternative or additional embodiments, for example Bluetooth®, Digital Enhanced Cordless Telecommunications (DECT), Zigbee®, or the likes, and/or that multiple signal-providing units (optionally of different types) may be provided on any given floor. References herein to WiFi are for convenience only and should be read more broadly.

Indeed, as described elsewhere some embodiments ambient signal data is utilised rather than radio-communication signal data. In such embodiments the ambient signal may be provided by visible light (such as from a camera), modulated light, geomagnetic, or the like.

Whilst on or near each floor 101-104, the mobile device 152 receives a signal from at least one of the WiFi access points 101a-104a. This signal provides radio-communication signal data (in this case, WiFi data), which is sent to the processing unit 160 by the mobile device 152 in the embodiment being described.

In the embodiment being described, the WiFi data is associated with the height data. WiFi and height data may be obtained simultaneously (data points at set time), or at different times and/or frequencies. A time stamp or other series stamp may allow the WiFi data to be associated with the correct portion of the height data (in this case, pressure data). The WiFi data is therefore segmented as part of the trajectory data. In the embodiment being described, the processing circuitry 152c is arranged to time stamp the data generated by the sensors 152a, b as the data is received/processed by the processing circuitry 152c.

Once the processing unit 160 has segmented the trajectories 110-130, similarity values are then calculated for pairs of segments based on the radio-communication signal data, or in other embodiments, the ambient signal data. In the embodiment being described, a similarity value is calculated for every possible pairing of segments (within a trajectory and between trajectories). A similarity value between a segment and itself may be set as a defined value, such as 1. A higher value may indicate a higher similarity, for example ranging from 0 to 1.

In the embodiment being described, the calculation of similarity values is performed by a WiFi similarity calculator of the processing unit 160. In alternative embodiments, the calculation may be performed by a separate processing unit, and/or by the mobile device 152.

Taking the example shown in FIG. 1A, the mobile device 152 may receive, for example:
a relatively strong signal from access point 101a and a weaker signal from access point 102a when on Floor 0;
a relatively strong signal from access point 102a and weaker signals from each of access point 101a and 103a when on Floor 1;
a relatively strong signal from access point 103a and a weaker signal from each of access point 102a and access point 104a when on Floor 2; and
a relatively strong signal from access point 104a and a weaker signal from access point 103a when on Floor 3.

In some situations, there may be multiple access points per floor, and/or access points on other floors may not be visible to a mobile device 152 on one floor.

The strength of each radio-communication signal may vary with location on the floor, for example due to distance from an access point or repeater, and/or obstacles to the WiFi signal. However, on average, the WiFi environment observed would be expected to be more similar for segments on the same floor than between floors, irrespective of the specific WiFi environment on each floor. The WiFi data may be referred to as a WiFi fingerprint.

Similar fingerprints would be generated for other forms of ambient-data. It is generally the case that ambient data is more similar for segments within a given floor than for segments between floors.

In the embodiment being described, a higher similarity value for a pair of segments is taken to indicate a higher probability of those segments being on the same floor.

In the embodiment being described, the WiFi similarity calculator takes as input all of the segmented WiFi data, and calculates a similarity index (more specifically Jaccard similarity in this embodiment, although the skilled person would appreciate that other similarity measures could be used) for all pairs of segments. Other embodiments may use measures such as the Tanimoto similarity, correlation distance, dynamic time warping distance or any other statistic based metric etc. and other ambient signals, for example, Bluetooth, cellular, visible light, geomagnetic data or any other signal that can be uniquely identified on repeated visits to the same location.

Referring to FIG. 2, T1 and T3 are trajectory segments originating from the same continuous trajectory. This implies that the pressure difference between the two is available from the pressure data (either a single pressure link if they are adjacent, or a sum of pressure links if there are other intervening segments). However, segment T2 belongs to a different trajectory and thus the pressure difference between T2 and T1 or T2 and T3 is not available, as absolute pressures are not relied upon in the embodiments being described. A WiFi (or other ambient signal) similarity metric can therefore be used in order to identify which segments are on the same floor, instead of relying on absolute pressure values for comparison.

Thus, the similarity between T1 and T2, between T1 and T3, and between T2 and T3 is computed. The similarity between T1 and T2 is high, as the two segments spatially overlap/are on the same floor. The similarity between T1 and T3 is low, as the two segments do not overlap/are on the same floor. The similarity between T2 and T3 is low, as the two segments also do not overlap/are on the same floor.

In the embodiment being described, the result is presented as a 3 by 3 similarity matrix, which summarises the relationship between all segments. The skilled person will appreciate that for n segments, the matrix would be an n by n matrix.

This similarity values, in this case in the form of a similarity matrix, are then used in grouping the segments.

In the embodiment being described, the segments are grouped into a plurality of groups based on the radio-communication signal data, using the similarity values. Similar segments (i.e. segments with more similar WiFi fingerprints) are grouped together.

In the embodiment being described, a hierarchical clustering method is used to group the segments. The skilled person will appreciate that any suitable grouping approach known in the art may be used. The segments are therefore mapped into groups based on the WiFi data. This may be referred to as a WiFi grouping, or WiFi fingerprint grouping.

In the embodiment being described, the total number of floors 101-104 of the building 100 is known and the initial number of groups is set to be equal to the number of floors. A clustering algorithm is arranged to divide the segments into k groups (also referred to as clusters), where k is the known number of floors. Conveniently, a k-means clustering algorithm is used. However, the skilled person will appreciate that any other suitable clustering algorithm may be used such as variations on the k means algorithm, including k-means++, fuzzy c means, k-medians or the like. Indeed, some embodiments may use other clustering methods such as distribution based clustering, density clustering or the like.

In alternative embodiments, the number of floors may not be known, and/or the number of clusters to be formed may not be set, or may be set to a value not equal to the number of floors.

Once the groups have been obtained, the groups are then error-checked using the height data.

In the embodiment being described, intra-cluster and inter-cluster checks are performed. The checking for errors in the grouping comprises:
(i) Inter-cluster: identifying any height links within a group, indicating that adjacent segments of the same trajectory (which therefore have a pressure link between them) have been wrongly assigned to the same group;
(ii) Intra-cluster: identifying any deviations of height links between pairs of groups above a second threshold, indicating that at least one height link between the two groups of the pair does not match an expected height difference between the two groups; and
(iii) Multi-cluster: identifying any inconsistencies among multiple groups e.g. group A is two floors above group B and group B is one floor above group C, but group A is four (instead of three) floors above group C.

The intra-cluster error check fails (i.e. one or more errors are deemed to be detected) if there are any height links between segments belonging to the same cluster. This is because it is contradictory for two adjacent segments on the same trajectory to both exhibit a pressure difference between them sufficient to indicate a floor change (i.e. greater than the first threshold) and simultaneously belong to the same floor.

The inter-cluster error check fails (i.e. one or more errors are deemed to be detected) if deviation of pressure links between one cluster and another exceeds a threshold. In the embodiment being described, the standard deviation is calculated and used.

Irrespective of the absolute pressures recorded on a particular day and by a particular device 152, it is expected that the pressure difference between Floor X and Floor Y will be the same (to reasonable accuracies). As such, if at least one pressure link between the two clusters is significantly different from the expected pressure difference between the two floors/the average of the pressure links between that pair of clusters, it suggests that at least one segment associated with the outlier pressure link is in the wrong group. As this test compares outliers to an average, it is still not necessary to know to which floor each cluster belongs.

In alternative or additional embodiments, other height data may be used in the same way, instead of or as well as pressure data, for example inertial data (e.g. using double integration to provide an estimate of height change), prior and/or side channel information, and an equivalent approach to error checking may be used.

In the embodiment being described, if these two checks are satisfied, the grouping of the segments into the k clusters is accepted without further checking.

If the two checks are not satisfied, the clustering is repeated. In the embodiment being described, the clustering is performed with more clusters, in particular increasing the number of clusters by one (k+1).

In alternative or additional embodiments, a different random seed may be used instead of, or as well as, an increase in the number of groups.

In alternative or additional embodiments, only those clusters or groups that fail error checks are separated in new clusters or groups such that these new clusters satisfy inter and intra cluster checks.

The error checking is then repeated for the new clusters.

Once the grouping is accepted, the clusters can then be assigned to specific floors. In the embodiment being described, the assignment to floors is performed using the height links, which in this case are pressure links. The groups are ordered in pressure order using the pressure links. If the floor plan of the building is available the highest pressure group is then matched to the lowest floor, etc.

In the embodiment being described, the assignment of clusters to floors is performed by assembling an N by N adjacency matrix of the mean pressure links between clusters (where N is the number of clusters), and feeding the result to the next module 304.

Height clustering is then performed. In the embodiment being described, the height data comprise pressure data and the height clustering is therefore pressure clustering. The skilled person will appreciate that other forms of height-related data may be used in other embodiments.

In the embodiment being described, the N by N adjacency matrix is grouped in order to map rows of the matrix to relative floor identifiers. Groups, and therefore the segments of each group, are assigned a relative floor number. In this embodiment, the grouping is clustering and is performed using a k-means clustering method; the skilled person will appreciate that any suitable method could be used.

The skilled person will appreciate that when a number of floors, k, is known and the number of clusters is equal to the number of floors, the N by N adjacency matrix will be a k by k adjacency matrix and each cluster formed in the height clustering should be identical to those formed by the clustering, assuming that each floor of the k floors has been visited. The skilled person will appreciate that the second round of clustering may therefore be unnecessary in such cases. A simple comparison of pressure links, for example, could be used instead.

If a number of floors, k, is known and the number of clusters is greater than the number of floors (or if one or more of the k floors were not visited), the height clustering allows multiple clusters of the clustering to be assigned to the same floor where appropriate, so reducing the number of clusters back to k, or to a number of visited floors smaller than k, as appropriate.

The skilled person will appreciate that, in some implementations, the adjacency matrix may be incomplete; i.e. there may be no pressure links available between some pairs of clusters. Steps may therefore be taken to complete the adjacency matrix in such cases; for example, a shortest path algorithm, such as the Floyd-Warshall algorithm, may be used. The skilled person will appreciate that any suitable approach known in the art may be used.

The skilled person will appreciate that any suitable approach known in the art may be used to provide the height data used to segment a trajectory. Thus, the segmented portions of a trajectory are linked by height links. Embodiments may potentially use any of the following, or other, methods to segment trajectories:
Using a pressure sensor, absolute pressure values could be used, with the highest average pressure value for a group indicating that the group belongs to the lowest floor, etc.;
Using an inertial sensor, vertical acceleration (converted to displacement through double integration) as a proxy to measure height. The skilled person will appreciate that, in practice, the typical signal-to-noise ratio of a MEMS accelerometer found in current smartphones is low and could risk inaccuracies;
If a floor number of each WiFi access point (or equivalent), or of some of them, is known, floor number could be assigned from the WiFi data in an embodiment that uses WiFi signal strength data as ambient signal data;
If a floor number of each Bluetooth beacon (or equivalent), or of some of them, is known, floor number could be assigned from the Bluetooth beacon data in an embodiment that uses Bluetooth beacon data as ambient signal data;
If an identifier, such as the name of a shop or café, is associated with each WiFi access point (or equivalent), or of some of them, that identifier may be used to infer a location, e.g. from knowledge of where that shop or café is.
If a segment is known to start or end or pass from one or more building entrances on a given floor, it can be associated to that floor.
More generally if any prior fingerprint or information about the sensed ambient signal is available that associates the ambient signal to a particular location or floor, it could be used to assign floor number.

The result is an assigned floor number 305 for each trajectory segment.

In the embodiment being described, if the inter- and intra-cluster checks are satisfied, and the number of clusters is equal to the known number of floors, k, the clusters are accepted without further checks. The same may apply if the number of floors is unknown.

In the embodiment being described, if the inter- and intra-cluster checks are not satisfied, for more than a predetermined threshold number of clustering operations, the segments and respective trajectories that contribute to errors are removed and handled in a post processing step.

In the embodiment being described, a floor assignment filter module 304 is used in the embodiments being described.

The floor assignment filter module 304 estimates the most likely floor assignment of segments of a trajectory as follows: it uses the trajectory's height links to estimate floor transition probabilities and the similarity of each segment of the trajectory to already floor-assigned segments of other trajectories to estimate observation probabilities. In the embodiment being described, a Hidden Markov Model is used to estimate the observation probabilities, but other embodiments may use other techniques.

FIG. 3 schematically illustrates a system 300, similar to that described above.

In the embodiment shown in FIG. 3, the WiFi data files are segmented based on the associated height data (pressure data) at the mobile device 152.

Receiving module 301 receives and loads the pressure-segmented WiFi data files. The WiFi data for a given segment may be referred to as a WiFi fingerprint for that segment. Each segment may include multiple data points, and therefore may include multiple WiFi fingerprints.

A computing module 302 then computes similarities between the WiFi fingerprints of different segments. The WiFi fingerprints may be referred to as WiFi events.

The similarity values and their associated segments are then passed to a WiFi clustering module 303.

A first, clustering, sub-module 303a of the WiFi clustering module 303 then groups the segments into clusters.

A checking sub-module 303b then looks for any errors in the clustering. In the embodiment being described, the checking comprises inter-cluster and intra-cluster checks as described above. In additional or alternative embodiments, the checking may comprise or consist of different checks, and/or one of the two checks described.

In the embodiment being described, the embodiment is arranged such that the number of clusters has a predetermined maximum number. Other embodiments may have additional criteria and/or alternative criteria that must be met. However, the embodiment being described includes a module 303c that checks as to whether the maximum number of clusters has been exceeded.

If it is determined that the number of clusters being used is still less than the maximum then error-handling sub-module 303d increases the number of clusters. In the embodiment being described, the error-handling sub-module 303d increases the number of clusters by one. The skilled person will appreciate that a larger increase may be used in some embodiments, that the size of the increase may depend on the number of conflicts identified, and/or that something else about the clustering process may be changed in addition to, or instead of, increasing the number of clusters (e.g. selecting a new random seed). In alternative embodiments, only those clusters that contain conflicts may be separated into further clusters or groups. In embodiments in which the number of clusters is not increased, no maximum number of clusters may be set, and/or no check may be performed to see if a maximum number of clusters has been exceeded.

The skilled person will appreciate that, in the embodiment being described, the grouping of the segments into each group is accepted if the checking for errors does not identify any errors, or the grouping is re-run if the checking for errors does identify any errors. In alternative embodiments, a small number of errors (compared to the number of segments) may be deemed acceptable, so a grouping may be accepted despite a non-zero number of errors. In such cases, the segments, and optionally the trajectories, relating to the error(s) may be deleted from the data set.

Once the number of clusters has been increased by the module 303d, then the system then returns to the clustering sub-module 303a.

If the checking sub-module 303b discovers that there are no conflicts (“False”), the clusters are passed to a height clustering unit 304 which is arranged to assign relative identifiers to the clusters; ie each cluster is assigned to a relative floor identifier. In the embodiment being described pressure clustering is used to order clusters by pressure (and therefore height), and to amalgamate any clusters that appear to be at the same height, as discussed above.

A floor assignment module 305 then assigns a floor number to each cluster produced by the height clustering unit 304, and thereby to each segment within the cluster. The skilled person will appreciate that it may not be possible to assign an absolute floor identifier to the relative floors. For example the number of relative floors generated by the module 304 may be different from the number of floors within the building, the number of floors within the building may not be known, etc.

The skilled person will appreciate that no pressure clustering may be performed in some embodiments. In such embodiments, the clusters formed by the WiFi clustering module 303 (or module clustering on other ambient signal data) may be passed straight to the floor assignment module 305, or a different check may be performed in between.

During the creation of the clusters, if the module 303c determines that the maximum number of clusters has been exceeded then a module 306 removes segments and/or the trajectories containing those segments from the data that is being clustered. This removal of the data should allow the clustering process to proceed and the relative floor assignment step 304 to be reached. In the embodiment shown in FIG. 3, after deleting the trajectories causing errors, the clustering is accepted and the system proceeds immediately to performing relative floor assignment 304. In alternative embodiments, such as that shown in FIG. 4 (discussed below), the clustering process may instead be continued with the reduced data set.

Once the floor assignment process has been completed in step 305, it may be possible to re-assign rejected segments and/or trajectories to a floor. A module 307 attempts this process

Other embodiments may comprise further modules. For instance, a further module may be used for post-processing of the data to check for any errors. Such a further module may be thought of as a floor assignment corrector module. In alternative or additional embodiments, different checking methods may be used, for example using an additional data type, or no post-processing may be performed.

The skilled person will appreciate that the system 300 may be provided by a single processor or processing unit 300, or by a plurality of different units in communication with each other. Each module 301-307 may be provided in software and/or in hardware.

FIG. 4 illustrates a method 400 of an embodiment.

At step 801, data corresponding to a trajectory is received. The data comprises height data and radio-communication signal data.

At step 802, each trajectory for which data has been received is segmented, using the height data. A change in height is used to indicate where one segment ends and the next begins; the segmentation is based upon the height changes.

In the embodiment described with respect to FIGS. 1 and 2, the data are received by a remote processing unit 160 from one or more mobile devices 152 and the remote processing unit performs the segmentation 802.

In the embodiment described with respect to FIG. 3, a mobile device 152 receives the data (from its sensors) and segments the data. The mobile device 152 performs the segmentation 802. The mobile device 152 then sends the segmented data to the processing unit 160.

In alternative embodiments, the remote processing unit 160 may receive 801 some unsegmented data and some segmented data, perhaps from different mobile devices 152, and may perform segmentation 802 when not already done by the mobile device 152.

In the embodiments being described, similarity values are calculated 803 for pairs of segments based on the radio-communication signal data. In the embodiment being described, a similarity value is calculated 803 for each possible pairing of segments.

In the embodiment being described, the remote processing unit 160 performs the calculation 803 of similarity values, in a similarity computation module 302 thereof. In alternative or additional embodiments, some or all of the similarity calculations may be performed elsewhere.

In the embodiments being described, the segments are then grouped 804 into a plurality of groups based on the radio-communication signal data, using the similarity values.

In the embodiment being described, the remote processing unit 160 performs the grouping 804 using the similarity values, in a clustering module 303. The grouping 804 produces a plurality of groups of segments.

In the embodiments being described, the groups are then error-checked 805 to check for inconsistencies in the grouping. In the embodiment being described, checks within and between groups are performed.

A determination is then made 806 as to whether or not the grouping contains any errors.

If the grouping is found to contain any errors, the grouping is then re-run 807, as long as a predetermined number of iterations has not been exceeded 808a. In the embodiments being described, an increased number of groups is used for the re-running of the grouping. However, if the predetermined number of iterations has been exceeded then data that is causing the errors (eg segments and/or trajectories containing those segments) may be removed from the cluster generation process 809 before the clustering is re-run. If data causing the errors is removed, a number of groups may not be increased, and/or a random seed or the likes may not be changed, for the re-running of the grouping following the removal. In alternative embodiments, instead of re-running the grouping after the removal of the trajectories causing errors, the present grouping with the trajectories causing errors omitted may be accepted 808b—i.e. the method may proceed straight from step 809 to step 808b.

In an alternative embodiment, only those groups that contain errors are further sub-divided into further groups.

If no errors are found, the grouping is accepted 808b in the embodiment being described.

Once groups (ie clusters) have been formed then a relative floor assignment 810, is made before an absolute floor assignment is made 811, if there is data available to verify the absolute floor assignment.

Further, an attempt is made in step 812 to assign any data that was rejected in step 809 to one of the floors that has been identified in steps 810 and/or 811.

In alternative or additional embodiments, further error checking may be performed before accepting the grouping, for example by clustering the segments based on the height data (for example using the height links). This may identify inconsistencies, and/or allow multiple clusters formed from the initial grouping 804 to be combined into a single cluster. This may occur, for example, if two areas of the same floor have different radio-communication signal environments due to different routers and/or radio-communication insulating structures being present. Due to the different radio-communication fingerprints, these segments may be split into two groups by the radio communication grouping 804. The two groups with different radio-communication fingerprints may therefore both belong to the same floor, and may be amalgamated into one group when clustered based on the height links. It will be appreciated that in other embodiments where an ambient signal other than a radio-communication signal is used then the discussion of this paragraph are equally relevant to the fingerprints of that ambient signal.

In alternative or additional embodiments, further error checking may be performed after assigning each group to a floor of the building 100.

Alternatively or additionally, different approaches may be used. For example, a floor location of a WiFi router associated with some of the WiFi fingerprints in the data may be checked and compared to the assigned floor number, and/or an observed SSID (wireless network name) from a floor can be compared to floor map information. Other prior information that associates a segment's ambient signal to a floor can also be used.

The skilled person will appreciate that the floor assignment described herein may be used as one component of a “pipeline” that is used to process crowdsourced data to automatically build Wi-Fi maps (or other radio communication signal or other ambient signal maps) of a building. Each trajectory (user path) in the crowdsourced dataset may comprise data from various sensors, e.g. accelerometers, gyroscopes, magnetometers, pressure sensors, Wi-Fi, Bluetooth and/or cellular radio (eg GSM, UMTS, 3G, 4G, 5G, etc) receivers and ambient light sensors, etc. A trajectory may start from outside or inside the building, and may start or finish on any floor, or between floors. A trajectory can traverse different floors in any sequence. For example, a user might enter the building from a particular entrance on the ground floor, change to the third floor and then down to the second floor, and then stop supplying data before exiting the building.

1. A method of automatically assigning segments of trajectories to corresponding floors of a building within which each trajectory is located, the method comprising:
receiving data corresponding to a trajectory from a mobile device moved along that trajectory, the data comprising height data and ambient signal data;
segmenting the trajectory into segments using the height data, such that a change in the height data greater than a first threshold marks an end region of one segment and a start region of an adjacent segment, a change in the height data between adjacent segments of the trajectory being referred to as a height link;
calculating similarity values for pairs of segments based on the ambient signal data;
using the similarity values, grouping the segments into a plurality of groups based on the ambient signal data;
checking for errors in the grouping using the height links, and in response to the checking:
if the checking determines that no errors exist, accepting the grouping of the segments into each group; and
if the checking determines errors exist, performing one of:
i) iteratively re-running the grouping and checking for errors; or
ii) rejecting one or more segments from the grouping process and accepting the grouping; and
once the grouping is accepted, assigning the groups to floor identifiers.

2. The method of claim 1 wherein the grouping is re-run in step (i) with an increased number of groups.

3. The method of claim 2, wherein iteratively re-running the grouping in step (i) comprises:
rejecting one or more segments; and
re-running the grouping without the rejected segments.

4. The method of claim 1, wherein the checking for errors in the grouping comprises:
(i) identifying any height links within a group, indicating that adjacent segments of the same trajectory have been wrongly assigned to the same group;
(ii) identifying any deviations of height links between pairs of groups above a second threshold, indicating that at least one height link between the two groups of the pair does not match an expected height difference between the two groups; and
(iii) identifying inconsistencies among the groups of segments.

5. The method of claim 4, wherein the deviations identified in check (ii) are standard deviations around the average height change of a height link between the two groups of each pair of groups.

6. The method of claim 5 wherein the first threshold and the second threshold are the same.

7. The method of claim 1 wherein the rejected segments are subsequently assigned to floor identifiers using the height links between segments to estimate floor transition probabilities and the similarities of a rejected segment to already floor-assigned segments of other trajectories to estimate the probability of a rejected segment belonging to that floor identifier.

8. The method of claim 7 wherein a Bayesian filter is used to make the subsequent assignment of segments to floor identifiers.

9. The method of claim 1, wherein data corresponding to a plurality of trajectories is received, the data for each trajectory being from a mobile device moved along that trajectory, and wherein a change in the height data between adjacent segments of the same trajectory is referred to as a height link.

10-12. (canceled)

13. The method of claim 1, wherein side channel information is used to augment the height data, wherein the side channel information may provide information about the start and end of segments and/or the height differences among them.

14. The method of claim 1, wherein the assigning the groups to corresponding floors is performed using the height links.

15. The method of claim 14, wherein the height links are or comprise pressure links and the assigning the groups to floors of the building, using the pressure links, comprises ordering the groups in pressure order using the pressure links.

16. The method of claim 1 wherein a similarity value is calculated for each possible pair of segments.

17. (canceled)

18. The method of claim 1, wherein the assigning each group to a floor of the building, using the height links, comprises:
generating an adjacency matrix of the average height differences between groups;
using the adjacency matrix, grouping the groups formed based on the ambient signal data, based on the height data, into height groups; and
assigning a floor identifier to each segment based on the height groups.

19-20. (canceled)

21. The method of claim 1, wherein the floor identifier is one of a relative floor identifier, identifying the floor in relative terms to other floors; and an absolute floor identifier, identifying the floor relative to the floor of a building.

22. The method of claim 1, wherein a number of floors, k, within the building is known in advance, and wherein further the grouping based on the ambient signal data is initially set to produce k groups.

23. The method of claim 16 wherein, if the grouping based on the ambient signal data is repeated due to error identification such that more than k groups are produced, the number of groups is then reduced back to k, or lower, in the grouping based on the height data.

24-26. (canceled)

27. A machine-readable medium containing instructions that, when read by a processing unit, cause that processing unit to perform the method of claim 1.

28. A computing apparatus arranged to automatically assign segments of trajectories to corresponding floors of a building within which each trajectory is located, the computing apparatus comprising:
one or more processing units arranged to perform the method of claim 1.

29. (canceled)

30. A system arranged to automatically assign segments of trajectories to corresponding floors of a building within which each trajectory is located, the system comprising:
a mobile device comprising sensors and arranged to be moved along a trajectory and to have an application installed thereon arranged to:
generate, by the sensors, data corresponding to the trajectory, the data comprising height data and ambient signal data; and
send the data corresponding to the trajectory; and
a processing unit arranged to perform the method of claim 1.
